(19) United States
(12) Patent Application Publication
(10) Pub. No.: US 2007/0216696 A1
(43) Pub. Date: Sep. 20, 2007

(54) System and method for document rendering employing bit-band instructions

(75) Inventors: Benjamin D. Capper, Sydney (AU); Abhijit Mandal, Ryde (AU)

Correspondence Address: TUCKER ELLIS & WEST LLP, 1150 HUNTINGTON BUILDING, 925 EUCLID AVENUE, CLEVELAND, OH, 44115-1414, US

(73) Assignee: Toshiba (Australia) Pty. Limited

(21) Appl. No.: 11/376,797

(22) Filed: Mar. 16, 2006

(51) Int. Cl. G06F 12/02; G06T 1/00

(52) U.S. Cl. 345/543; 345/522

(57) ABSTRACT

A system and method for rendering of electronic documents includes interpreting of page description language to generate a series of instruction arrays corresponding to each of a plurality of bands that conjoin to form a rendered document output. Each instruction array includes instructions descriptive of a band of pixels to be generated corresponding to a scanline of an output image. Instructions include one or more image primitives described in the original, electronic document. The system allows for efficient, compact document rendering including multiple or mixed image or text areas that may overlap in an output document.

### BACKGROUND OF THE INVENTION

This application is directed generally to the field of rendering bitmapped images from encoded descriptions of electronic document files, and more particularly to efficient rendering of complex electronic documents that may include plural or varied image types.

A typical document output device, such as a laser printer, inkjet printer, or other bitmapped output device typically generates a bitmapped output image from rendering completed by raster image processing (“RIP”). A higher level description language is typically associated with an electronic document. This is often referred to as a page description language or PDL. There are many page description language formats. They may emanate from an application, such as a word processing package, drawing package, computer aided design (“CAD”) package, image processing package, or the like. Such files may also emanate from document inputs, such as from electronic mail, scanners, digitizers, rasterizers, vector generators, data storage and the like.

A raster image processor typically decodes a higher level description language into a series of scanlines or bitmap portions that are communicated to a bitmapped output such as noted above. While an entire sheet (or more) of bitmapped image data is suitably prepared at one time into a page buffer and subsequently communicated to an engine, this requires a substantial amount of memory. Earlier raster image processors would therefor employ a scheme by which one band of pixels were extracted at a time from a page description, and this band would be buffered and communicated to an engine for generation of graphical output. A series of bands were thus generated and output to complete one or more pages of output. It is often difficult to extract accurate band information, particularly when an input page description includes multiple images or mixed data types, such as graphics, text, overlays, and the like. In some earlier systems, generation of bands directly from a higher level, page description also requires that conversion to bands be completed at a timing that corresponds to a rate at which input is expected by a downstream engine.

It would therefore be desirable to have an image rendering system and method that allows for efficient use of memory, accommodates page description language input inclusive of multiple input data types and accommodates image generation with timing independent of capabilities of a graphics output engine. The subject invention addresses these concerns, and others, and teaches a raster image processing system and method that allows for accurate, memory efficient renditions from complex page description files.

### SUMMARY OF THE INVENTION

In accordance with the subject invention, there is provided an image rendering system and method that allows efficient use of memory that accommodates page description language input inclusive of multiple input data types and accommodates image generation with timing independent of capabilities of a graphics output engine.

Further, in accordance with the subject invention there is provided a raster image processing system and method that allows for accurate, memory efficient renditions from complex page description files.

Still further, in accordance with the subject invention, there is provided a system for rendering output from electronic documents that includes a memory allocation unit including a scanline memory allocation means adapted for allocating a plurality of scanline memory locations, each scanline memory location corresponding to a scanline of a document to be rendered, and an instruction memory allocation means for allocating at least one instruction memory location corresponding to each scanline memory location. A receiving means receives an electronic document inclusive of at least one encoded visual output primitive. A conversion means converts each visual output primitive of a received electronic document into a series of instructions and an association means associates each instruction with at least one scanline memory location. Each instruction is stored in an instruction memory location allocated by the memory allocation unit and corresponds to a selected scanline memory location. An encoded scanline output file, inclusive of content of each instruction memory location corresponding to each scanline memory location, is output to an associated document rendering device.

In accordance with a more limited aspect of the subject invention, an encoded scanline output file is communicated to a decoding means adapted for sequentially decoding instructions of each scanline memory location and a bitmap band output is generated that corresponds to decoded instructions of each scanline memory location.

In accordance with another aspect of the present invention, each instruction specifies at least one of color, opacity, pattern, and raster operation code.

In accordance with still another aspect of the present invention, included is means adapted for receiving the electronic document inclusive of a plurality of encoded visual output primitives, such that at least one scanline memory location includes instructions corresponding to each of the plurality of encoded visual output primitives.

In accordance with another aspect of the present invention, there is provided a method for accomplishing rendering of electronic documents corresponding to the above-summarized structure.

An advantage of the present invention is the provision of a document rendering system and method that enjoys a load reduction on associated memory management subsystems caused by typical page buffering operations.

Another advantage of the present invention is the provision of a document rendering system and method that allows for lower usage of memory during page rendering.

Still another advantage of the present invention is the provision of a document rendering system and method that implements a simplified, write-only display list system and allows for bypassing any need to read from an intermediate representation format prior to time of rendering.

Still another advantage of the present invention is the provision of a document rendering system and method that facilitates simplified transparency and raster operations.

Yet another advantage of the present invention is the provision of a document rendering system and method that optimizes performance and intermediate representation memory size.

Yet another advantage of the present invention is the provision of a document rendering system and method that promotes graceful performance degradation when confronted with difficult document output jobs.

Yet another advantage of the present invention is the provision of a document rendering system and method that allows for high rendering performance by exploitation of processor caches.

Yet another advantage of the present invention is the provision of a document rendering system and method that is advantageously implemented via software, via hardware or via a combination thereof.

Still other objects and aspects of the present invention will become readily apparent to those skilled in this art from the following description wherein there is shown and described a preferred embodiment of this invention, simply by way of illustration of one of the best modes suited for to carry out the invention. As it will be realized, the invention is capable of other different embodiments and its several details are capable of modifications in various obvious aspects all without departing from the invention. Accordingly, the drawing and descriptions will be regarded as illustrative in nature and not as restrictive.

### BRIEF DESCRIPTION OF THE DRAWINGS

The subject invention will be described in connection with a series of figures, which are used to disclose the preferred embodiment of the invention, and not for the purposes of limiting the same, wherein:

FIG. 1 is a flow chart of the overall diagram of the subject image rendering system;

FIG. 2 illustrates organization of a page representation in connection with the subject invention;

FIG. 3 illustrates a sample image for rendering in connection with the subject invention;

FIG. 4 illustrates a starting page representation for the rendering the sample image illustrated by FIG. 3 in connection with the subject invention;

FIGS. 5A and 5B illustrate representative flowcharts for embodiments of image rendering in connection with the subjects invention;

FIGS. 6A-6C illustrate representative raw pixels and run lengths of a example rendering in connection with selected embodiments of the subject invention;

FIGS. 7A-7C illustrate CYMK pixels and run lengths of an example rendering in connection with selected embodiments the subject invention;

FIG. 8 illustrates a representation of a sample image in connection with the subject invention;

FIG. 9 illustrates a representation of another sample image in connection with the subject invention;

FIG. 10 illustrates a bitmap of a representative character “N” in connection with the subject invention;

FIG. 11 illustrates a bit map line of the “N” character illustrated in FIG. 10;

FIG. 12 illustrates a representation of text elements in connection with the subject invention; and

FIG. 13 illustrates a representative instruction buffer in connection with the subject invention.

### DETAILED DESCRIPTION OF THE PREFERRED EMBODIMENTS

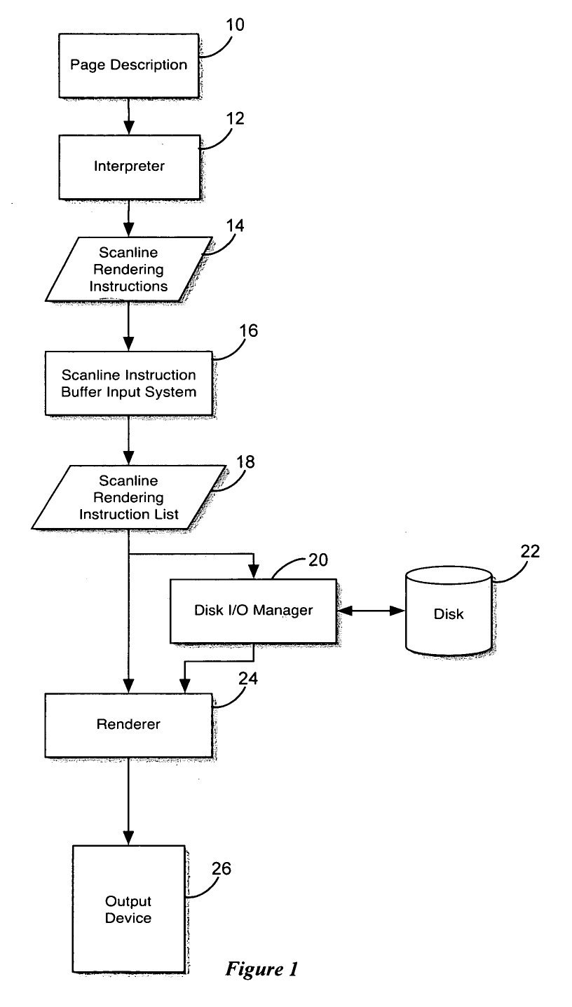

Turning now to the drawings wherein the illustrations are for the purpose of describing the preferred and alternative embodiments only, and not for the purpose of limiting the same, FIG. 1 illustrates an overall flowchart of document rendering in connection with the subject invention.

The system of FIG. 1, which will be detailed below, facilitates several key features. These include an ability for securing a partially rendered scanline based on an ordered instruction sequence. It also includes a system for two-path rendering, such as is encountered in high level/low level rendering. Further, the system is feed forward in nature, thus allowing for an efficient rendering operation. The system of FIG. 1 provides for low-level display list rendering. It is advantageously used in connection with raster image processing (“RIP”) at a low-level thereof. The system is suitably implemented at a point when a RIP engages the marking of pixels on a page. Such low-level operations include such functions as rendering a band of pixels from x to x1 at a scanline y in a specified color. Another suitable low-level operation is a rendering of a row from a glyph bit map to an x to x1 at scanline y in a specified color. Still another suitable low-level operation includes rendering a group of pseudo run length encoded (“RLE”) pixels from x to x1 as scanline y in a specified color.

In the overall system description of FIG. 1, the process commences with an input of an electronic document, suitably in a page description language, at block 10. This page description language (“PDL”) is communicated to an interpreter at block 12. Instructions interpreted at block 12 are communicated for generation of scanline rendering instructions at block 14. These scanline instructions are then buffered at 16 and generate a scanline rendering instruction list at block 18. Such instructions are suitably communicated directly to a renderer at block 24, or alternatively communicated to a disk input/output manager at block 20 that works in concert with a suitable storage system 22, such as a disk or other volatile or non-volatile memory. The renderer referenced at block 24 then communicates a rendered document for output at block 26 via an output device. Suitable output devices include any dot matrix or pixel based output, such as a laser printer, ink jet printer, facsimile machine, and the like, as well as for storage of a bit map image for later rendering in any suitable memory.

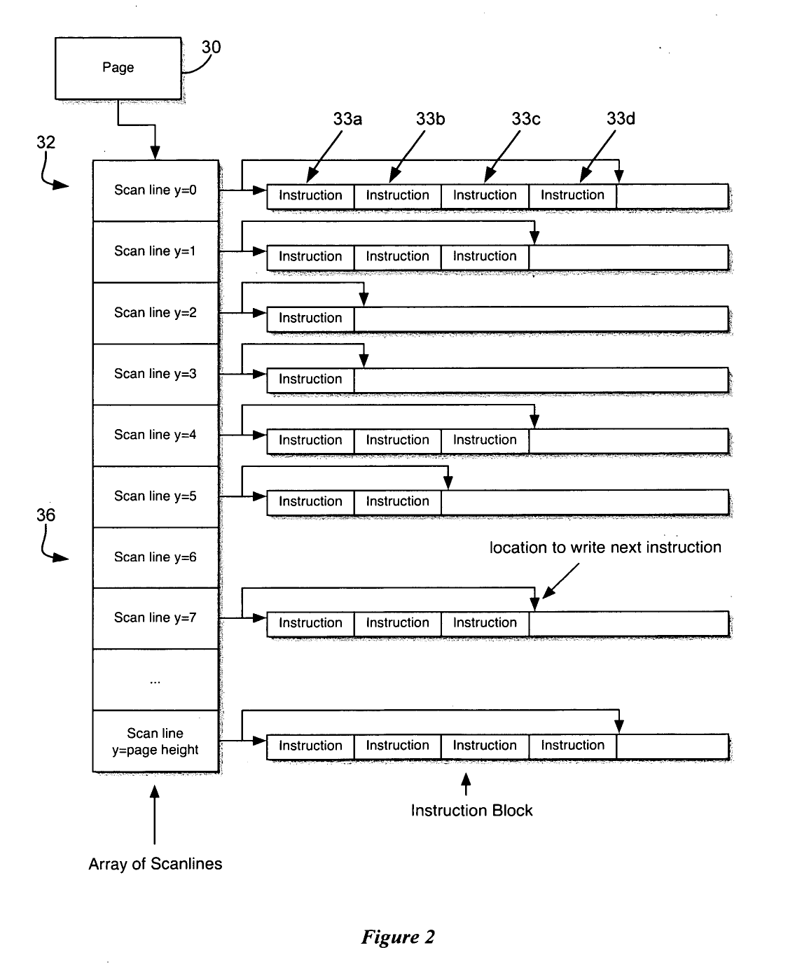

Turning now to FIG. 2, illustrated is a page representation format as used in connection with the subject invention. As noted above, the current system advantageously uses a low-level display list. Rather than actually rendering pixels, the subject system provides for storing of rendering instructions that describe each page, as well as a method of replaying those instructions at such point and time an image is to be banded out to an output engine.

The subject system treats a page as an array of scanlines. As used herein, a scanline is a complete row of pixels on an output page. Each scanline is suitably represented by a sequence of encoded instructions that will result in a rendering of that scanline. Scanline rendering instructions are stored in one or more instruction blocks, which instruction blocks are suitably fixed-size blocks of memory, allocated from an associated memory pool.

From the illustration of FIG. 2, it will be appreciated that a page 30 is represented as a series of scanlines y=0 through y=n, wherein n is defined as a number of scanlines associated with page 30.

Turning to a representative scanline 32, it is noted that this scanline is completed at y=0 on the page 30. The scanline y=0 is represented as a series of instructions 33, a number of which corresponds to a depiction evident from the scanline 32 as will be appreciated from an understanding of the description below. In the representation of FIG. 2, such instructions correspond with scanline y=0, inclusive of instructions 33a, 33b, 33c and 33d. It will be appreciated that a similar set of instructions are associated with each scanline y for the entire page emanating from that page 30. It will be appreciated further that depending on a complexity of a content associated with the scanline, fewer or more instructions may be necessary as will be appreciated from the reading below. In addition to the foregoing, each scanline contains pointer data which functions to point to a next available area of an instruction block to which a next instruction will be added. In the preferred embodiment, each scanline also includes a graphics state which state functions to store information about a current state of specified graphics parameters associated with that scanline.

During a RIP process, instructions are added to or appended to a scanline following a previous instruction associated with a particular instruction block. In the event a scanline is empty, such as illustrated at scanline 36 where y=6 in FIG. 2, the system suitably allocates a new, empty instruction block. In the preferred embodiment, the system does not require a read from an instruction block during the encoding or translation process, only functioning to append instructions in each instance. It will be appreciated that at a point when a banding of a page is being made to an output controller, the system functions to play back instructions to render individual scanlines prior to passing them to a printer system for output therefrom.

In the preferred embodiment, memory associated with each scanline functions to store graphic state information. This state information is suitably used both during a process of adding instructions to a scanline, as well as during a final rendering process. However, it is to be appreciated that in certain situations, it may be advantageous for performance reasons to create a localized cache of selected information. Suitable information for this graphic state includes a current color associated with the scanline. A suitable default color is suitably black.

Graphic state information also suitably includes current opacity associated with a scanline. In a preferred embodiment, the default opacity is fully opaque. Graphic state information also suitably includes a current raster operator (“ROP”), such as is used in connection with a printer control language (“PCL”). Any suitable printer control language is appropriate. However, a preferred embodiment employs PCL/XL formerly known as PCL 6, as propagated by Hewlett-Packard. A suitable default ROP is 0. An additional state entry is suitably a current pattern, with a suitable default being no pattern. As will be appreciated below, the subject system teaches modification and usage of such graphic state elements.

In the subject system, a byte-code style instruction format is suitably employed. This consists of an opCode which is typically one byte. An opCode is suitably followed by one or more parameter bytes, as well as optional embedded data. Selected opCodes suitably include selected state information. Such opCode types suitably effect changes that affect all following instructions, such as opCodes that modify a scanline graphics state.

The subject system advantageously uses four opCodes. General band rendering is suitable for representations, such as line art. A graphic state is suitable for setting a current color, ROP, ternary ROP (“TROP”), pattern, and the like. An opCode is suitably provided for batch pixel rendering and caching. This facilitates image rendering, patterns, PostScript shading, portable document format (“PDF”) shading, and the like. Additionally, opCodes are suitably provided to correspond to a text rendering. It will be appreciated that many such opCodes are available in published and updated regularly for use in connection with PDF, PCL, PostScript, and any other suitable document language.

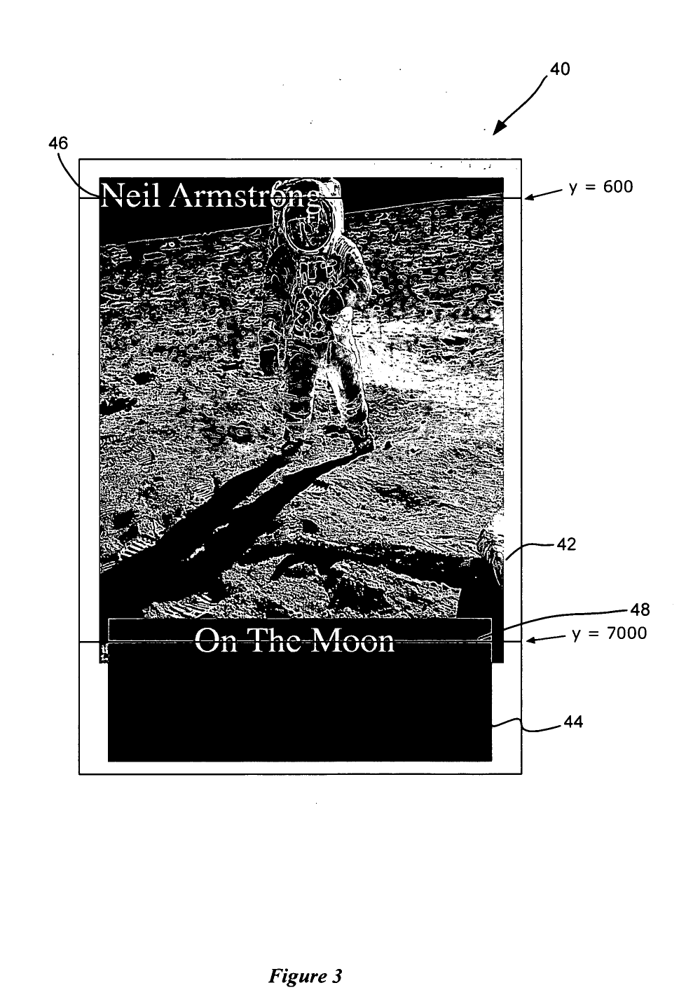

Turning now to FIG. 3, a representative rendering using the subject system will be described using a representative sample image 40. The system is commenced by initialization of disk input/output (“I/O”) and memory subsystems, allocation and initialization of scanline array (including a scanline graphics state) to default or empty values. Suitable disk and memory systems will be described in more detail below. In the representative image of FIG. 3, four elements are illustrated. A first element is that of an image 42 depicting Neil Armstrong on the moon. While the image 40 of FIG. 3 is in black and white, it will be appreciated that the subject rendering functions in color, as well as black and white images. In the description herein, it is assumed that the image 42 is in gray color to facilitate a clear understanding of the subject invention. Next, the image 40 includes a vector graphics element 44, illustrated as a rectangular portion 44 positioned at a bottom of the image 40. The system also illustrates two text objects, a first object 46 being “Neil Armstrong” that is superimposed over the pictorial area 42, and the second object 48 being the words “On The Moon,” rendered in white, and superimposed on the rectangular area 44.

In FIG. 3, two representative scanlines, y=600 and y=7000, have been selected for purposes of illustration. The scanline y=600 intersects both the image 42 and the text 46. The scanline y=7000 intersects the image 42, rectangle 44 and text 48. First, descriptions for each of the portions, graphic, shape and text, will be described individually.

Turning first to the image of Neil Armstrong 42, a suitable mechanism for accomplishing a description will be described. A pictorial image, such as that 42, is suitably represented in a left to right format. Cases of pure image rendering are frequently encountered during raster image processing operations. For the description herein, it is assumed that a source image is at the same resolution as that of a document output device, such as a printer. By way of an example only, such a resolution is suitably 600 dots per inch. However, it is appreciated that any resolution is suitably utilized, both for an input and output resolution level. It will also be appreciated that translation between resolutions in an input and output is contemplated, and is suitably accomplished with scaling instructions as appreciated from the subject description. Also, for purposes of illustrating the example, suitable 8-bit gray image is allocated. It is to be further appreciated that any suitable palette representation such as CMY, CMY(K), RGB, or any additive or subtractive primary color set, is suitably used. As a general rule, additive primary color sets are advantageously used in active display generators such as video display devices, and subtractive color sets are advantageously used in passive displays, such as printouts.

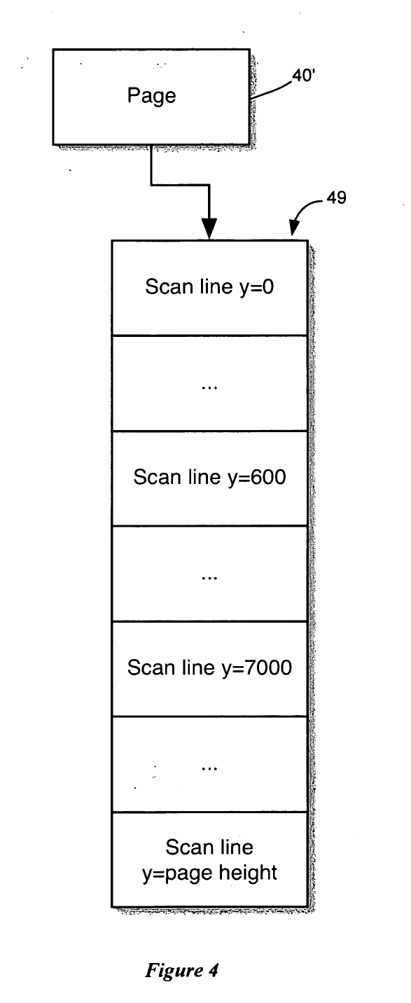

FIG. 4, illustrated is a commencement of a building of a representation of the image of FIG. 3 which image is represented as an electronic document at 40′. Reference numeral 49 illustrates an array of scanlines associated with each, one associated with each of both associated electronic page 40′ corresponding to the picture 40 illustrated in FIG. 3. At a commencement of building a description of the image represented by the electronic page 40′, no instruction blocks are allocated and all scanline structures in array 49 are set with default values.

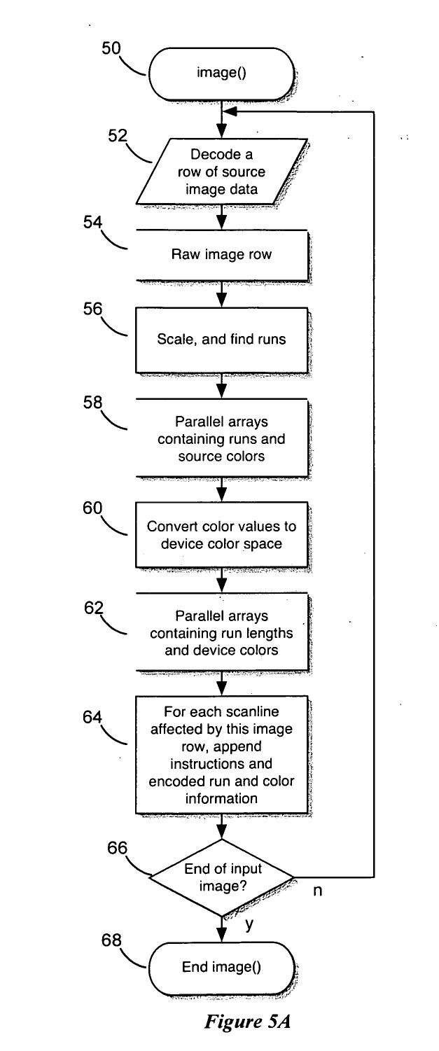

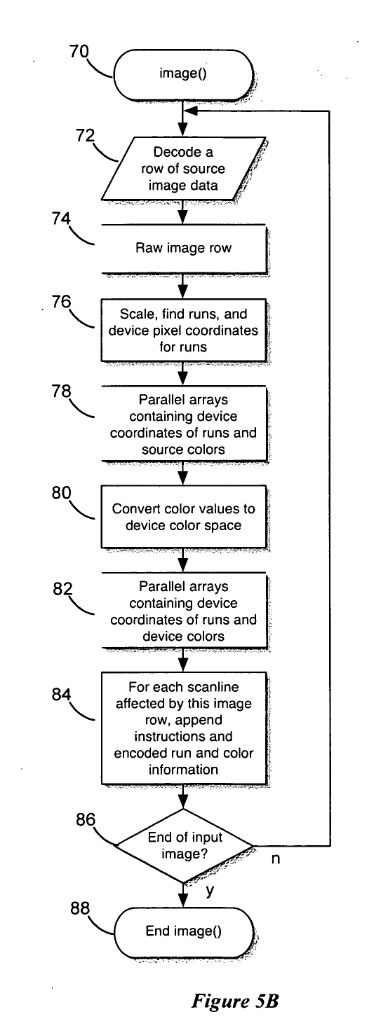

A build process for the image is detailed with additional review of the flowchart of FIG. 5A. In that flowchart, an image is received at step 50. A row of source images is decoded at step 52 to form a raw image row illustrated at step 54. Next, a scaling and determination of run length is completed at step 56. Once this is completed, progress is made to step 58, at which point a buffering is made which contains a series of input color values and pixel runs. Thereafter, a conversion is made of color values to a device specific color space associated with an output at step 60. This value is buffered to a series of device color values and pixel runs at step 62. Next, at step 64, each scanline that is affected by a particular row has appended thereto instructions relative to a color and run length buffer associated therewith. Next, at step 66, determination is made as to whether each row of an image has been completed. If not, progress is returned to step 52 with a next row. Upon completion of a last row, the procedure ends at step 68.

In summary, processing for a source image, such as a representative picture, proceeds for each row of source image pixels. Scaling is completed, if needed. In the example, both an image input and output are fixed at a corresponding 600 dots per inch. Thus, in such a situation, scaling would be unnecessary. Color values and a corresponding run length are buffered. These values are converted into a color space of an associated output, such as CYMK in a typical output. The system calculates which scanlines are affected by a row being rendered. A corresponding instruction to render that source image row is appended to an instruction block associated with that scanline. This process is completed for each row.

In the representative image of FIG. 3, pictorial portion 42 affects both scanlines at y=600 and y=7000. Accordingly, during a conversion of data associated with entire image 40, at some point rendering relative to portion 42 will result with instructions being placed at these scanlines.

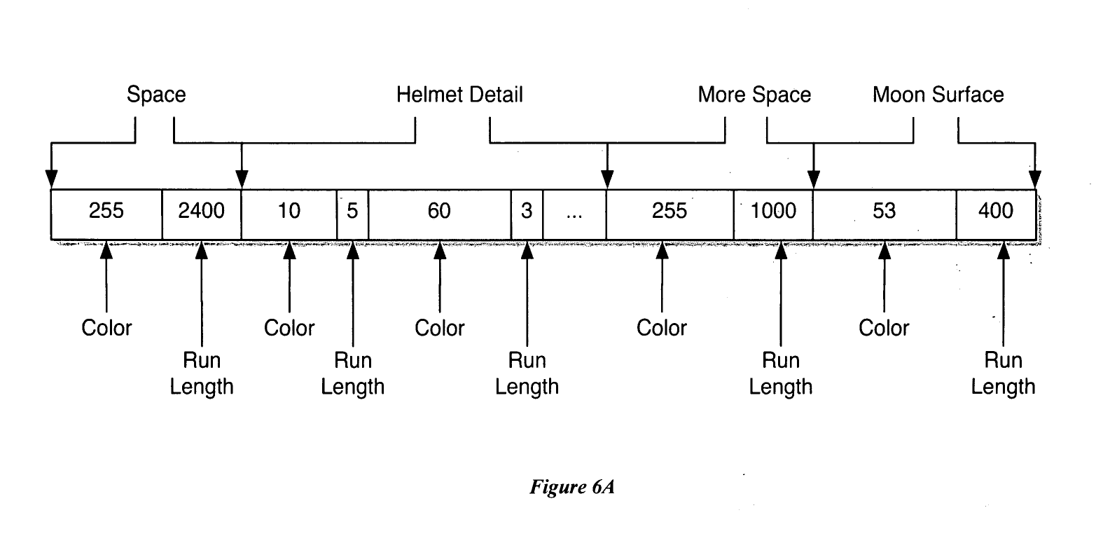

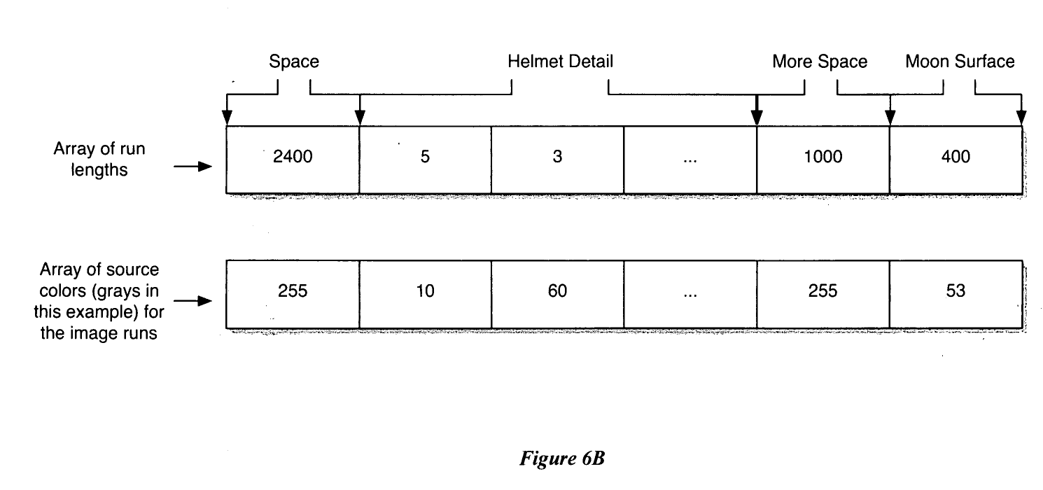

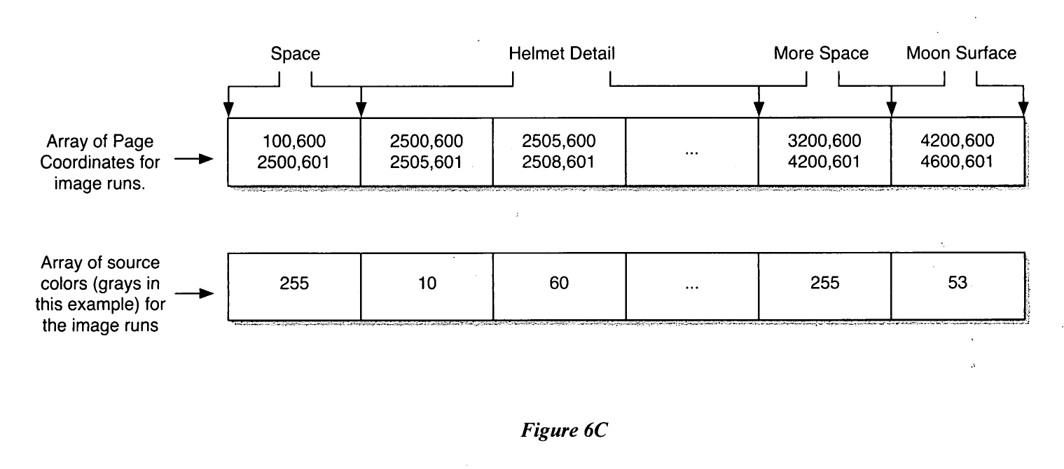

Turning to representative scanline at y=600, an image will have been retrieved from a source, such as a gray image row, from an input that is to be rendered. Since both input and output are set in the example at 600 dpi, no scaling is required. A good portion of the scanline at y=600 will be black and featureless. This would be followed by some detail for the top of the helmet, followed by more black space and moon detail at the far right. Once this line is completed, a suitable representation will be generated which is depicted at FIG. 6A. While actual representation in complexity would vary this description, it is sufficient for illustration of the preferred embodiment.

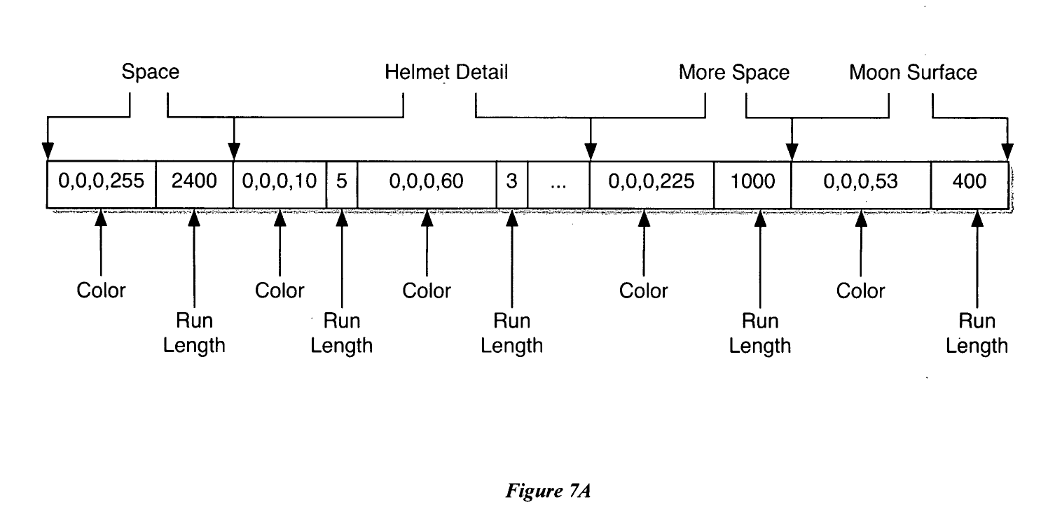

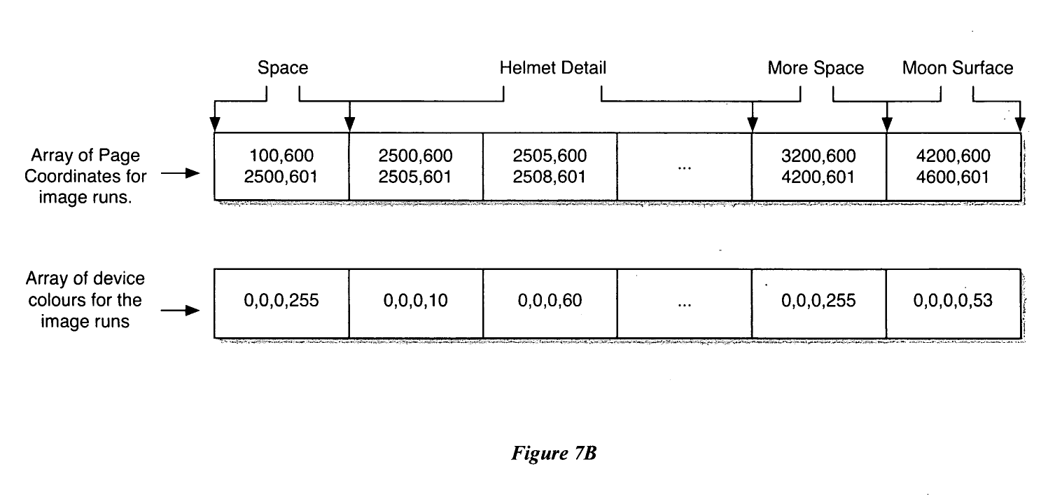

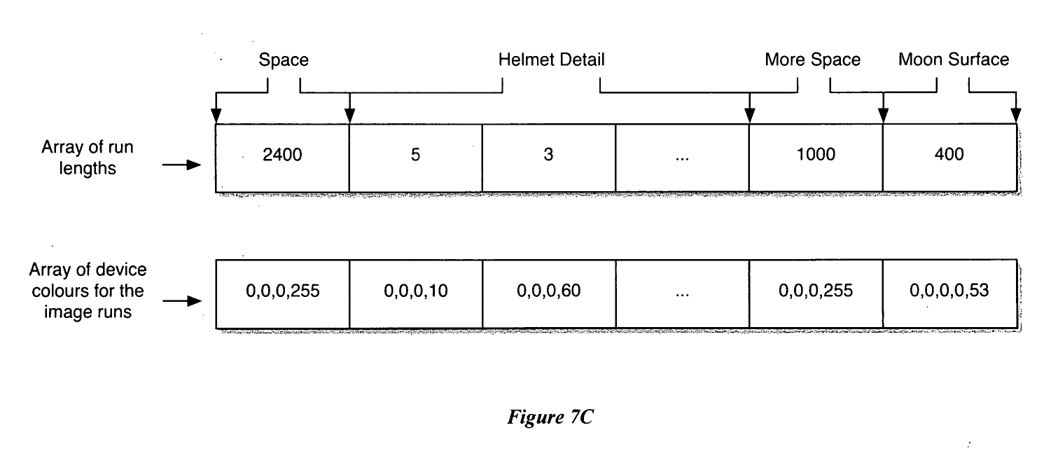

Next, turning to FIG. 7A, an illustration is made of a representation once a conversion is made to a color space of a suitable output device. As with FIG. 6A, this representation is provided for illustration purposes only. An actual description will vary relative to more precise details and properties of an input and output image. Information of FIG. 7A is suitably organized according to an image page, commencing at a selected coordinate on corresponding to a scanline at y=600. An instruction block is allocated. This instruction block suitably includes a one byte code signifying a suitable opCode. In a first instruction block, a suitable value is representative of a beginning opCode. A next opCode is formed which sets a starting x coordinate of the image. Next, values such as that illustrated in FIG. 7A, are converted to a suitable image data encoding scheme. This process is completed for each row associated with an image until an entire image has been processed.

FIGS. 6B and 7B illustrate an alternative embodiment to that illustrated in connection with FIGS. 6A and 7A, above. As with FIG. 6B illustrates alternative encoding of source values in a color image and FIG. 7B illustrates alternative encoding after conversion to a color space of a suitable output device. In each, two parallel arrays are used to encode values. In both, first array is that of run lengths, and a second is an array of color values. It will be appreciated that this embodiment, page coordinate values of FIG. 7B are encoded in an array format:

x₀,y₀

x₁,y₁

defined as page coordinates of an associated image run. Thus, a first image run of a black value, suitably 255 in an 8-bit representation, is from x=100 to 2499, which is one pixel high at y=600. Values of x₁ and y₁ are non-inclusive, such that a height of a corresponding run is y₁−y₀ with a width of y₁−y₀.

FIGS. 6C and 7C illustrate an embodiment corresponding to that of FIGS. 6B and 7B wherein a grayscale image is encoded. In this embodiment, C, Y, M values are all zero, and thus an output is considered to be in a grayscale. Thus, it will be appreciated that that all embodiments contemplate color or grayscale rendering.

FIG. 5B illustrates a flowchart of a build process for the image in parallel array format as illustrated in connection with FIGS. 6B, 7B and 6C, 7C, above. In that flowchart, an image is received at step 70. A row of source images is decoded at step 72 to form a raw image row illustrated at step 74. Next, a scaling and determination of run length is completed at step 76. Once this is completed, progress is made to step 78, at which point a buffering is made which contains a series of input color values and pixel runs. In this embodiment, it will be noted that parallel arrays are formed. Thereafter, a conversion is made of color values to a device specific color space associated with an output at step 80. This value is buffered to a series of device color values and pixel runs, also formed as parallel arrays, at step 82. Next, at step 84, each scanline that is affected by a particular row has appended thereto instructions relative to a color and run length buffer associated therewith. Next, at step 86, determination is made as to whether each row of an image has been completed. If not, progress is returned to step 72 with a next row. Upon completion of a last row, the procedure ends at step 80.

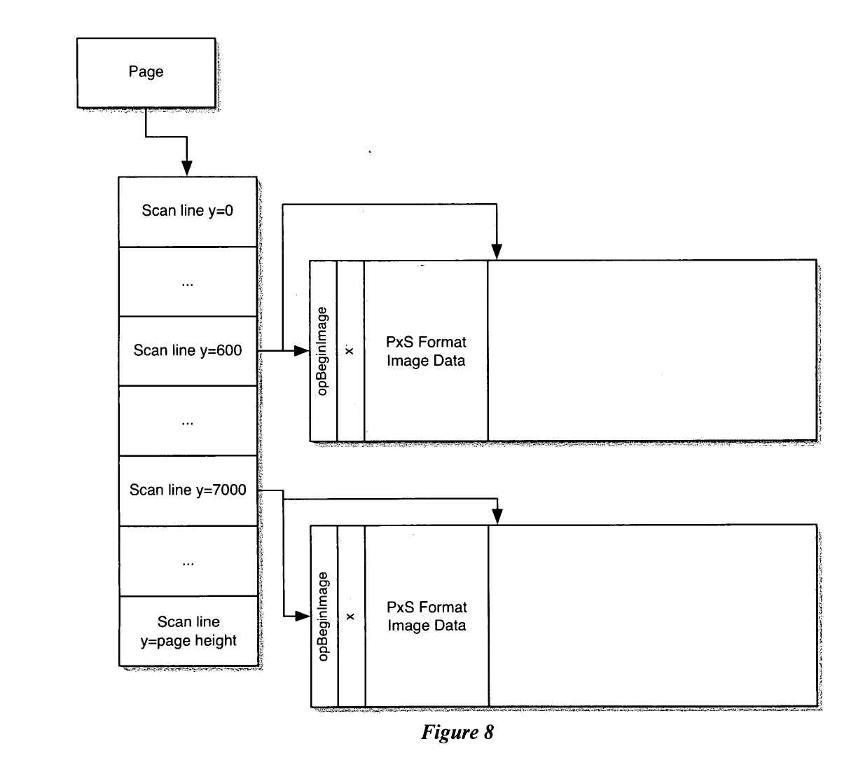

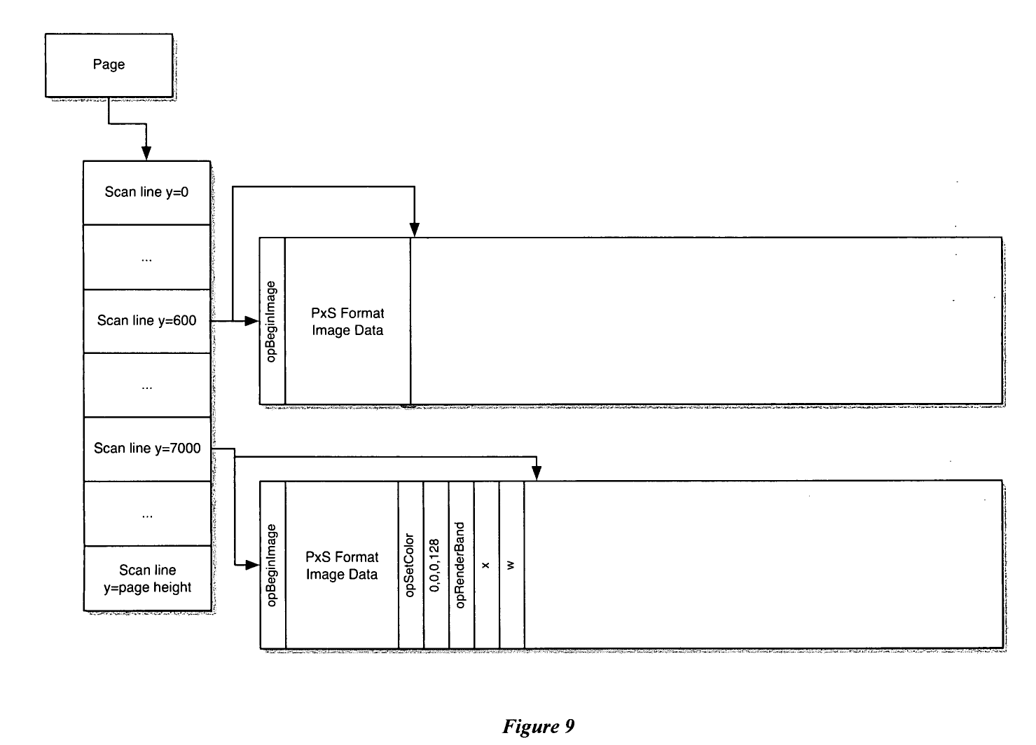

Turning to FIG. 8, illustrated is a portion of a complete representation inclusive of the image portion 42, as represented by locations at y=600 and y=7000. It will be appreciated that all aspects of the image 42 will have corresponding entries in the respective scanlines. Turning to FIG. 9, description will be made relative to the rectangle 44 of FIG. 3. In this example, gray rectangle 44 is suitably represented in vector form. In a suitable vector rendering, a decomposition of a shape is made into trapezoids, and then to single scanline bands. However, it is to be appreciated that in many other cases, by way of example, a complex shape will result in a series request to draw individual one pixel high bands.

Rendering of a vector rectangle is straightforward. A scan conversion will result in a request to render one band per output scanline with each band having a same starting x coordinate and width w. The subject system need not be concerned whether a rectangle overlaps with an image portion, such as that 42 described above. For composite images that include, for example, image data and vector data, vector data, such as a rectangle description, will be appended after image data and instruction block for that scanline. In the subject description, it is unnecessary to determine or specify whether a drawing appears above or below an underlying object once rendered.

In the example of rectangle 44, a conversion will eventually result in a series of requests to draw one pixel high bands. For each request, determination is made to see whether an effective scanline has an instruction block allocated to it. One is allocated if this has not yet been completed. Next, a determination is made as to whether a current color for a scanline matches that which is to be rendered. If not, appropriate opCodes are set to select a required color. Next, opCodes associated with rendering are appended to each affected line associated with a starting x coordinate and a length of the corresponding band. In the rectangle portion 44, processing will eventually lead to a scanline, such as y=7000, wherein memory has already been allocated and therefore it is unnecessary to allocate such memory again. As with the image portion 42, described above, default color is selected, such as black, and instructions will be appended as necessary to set an appropriate color. By way of example, a gray rectangle will set values suitably to 0, 0, 0, 128 which defines an 8-bit component level CYMK gray defined by 4 bytes. Continuing on scanline 7000, a byte code for an opCode to render a band, (“opRenderBand”) is suitably appended to an instruction block, followed by a starting x coordinates, suitably 2 bytes and a width value w, also suitably 2 bytes.

It will be appreciated from the foregoing that the subject representation has therefore includes information both as to a picture portion 42, as well as a rectangle portion 44. Next, construction of text space elements will be described.

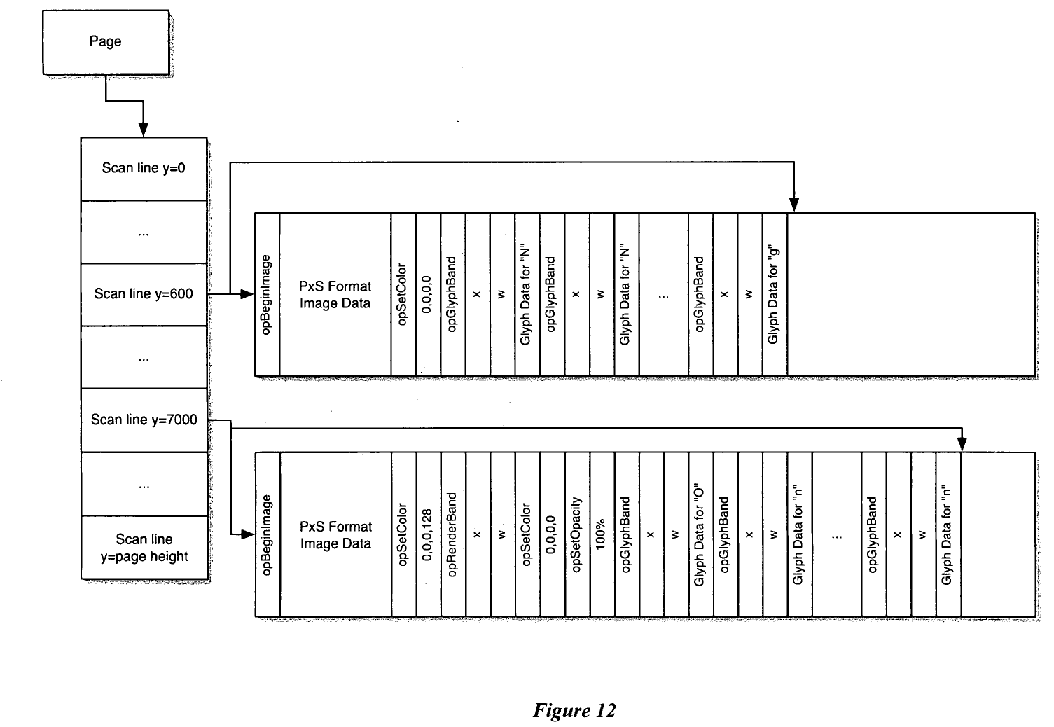

In the sample image 40 of FIG. 3, the text aspects include those strings 46 and 48. To render text information, a request is first made to render a required character at the required size into a one bit glyph in memory. For each row in a glyph bit map, instructions are added to render that row to the appropriate output scanline in a required color. Next, a current color is selected if necessary. Insofar as, in the representative example, a default color for all scanlines is black, this must be set to white for the text of string 46. This suitably accomplished with an opCode, such as a one byte code as opSetColor to a selected value. By way of example in CYMK color space, 0, 0, 0, 0, suitably represents a four byte value of white. In scanline 600 of FIG. 12, a one byte code for opGlyphBand, two bytes for a next coordinate where a glyph begins, two bytes for a width of a glyph are appended.

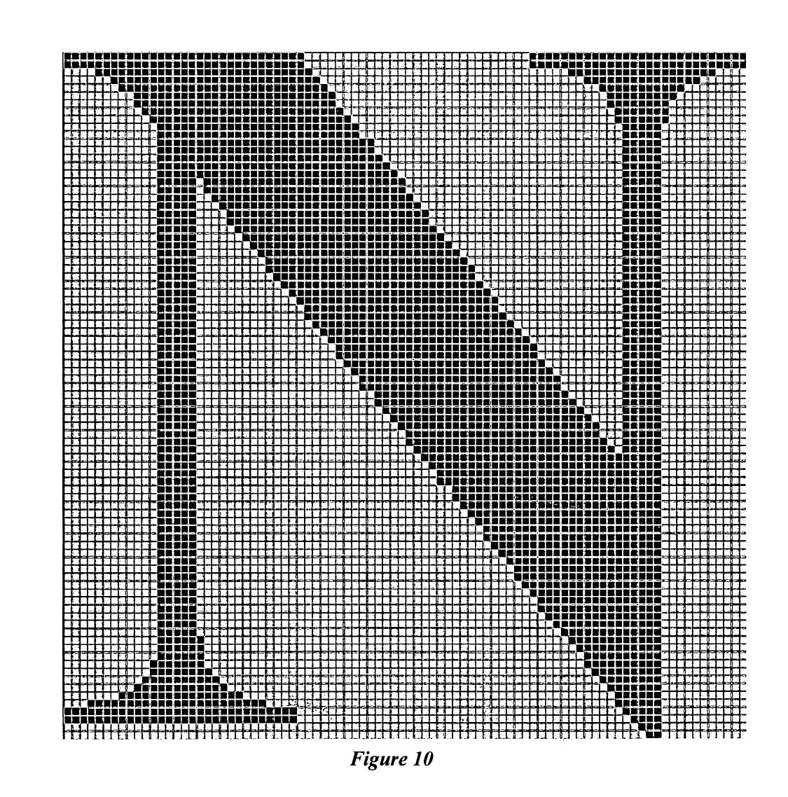

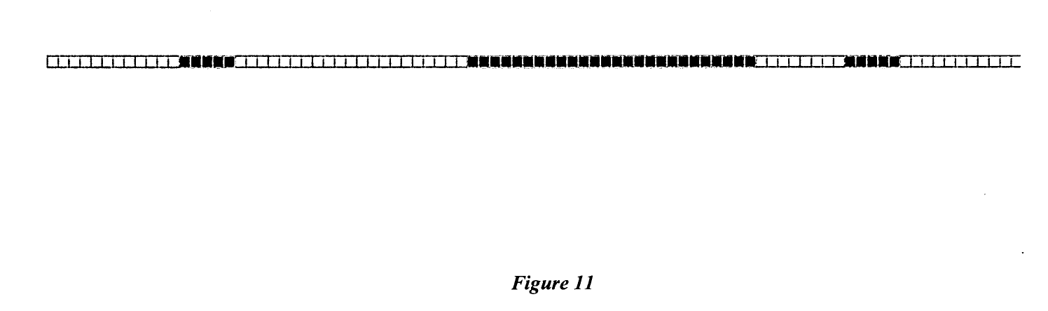

Turning to FIG. 10, illustrated is a character “N” corresponding to first character in text string 46. FIG. 10 illustrates a suitable one bit glyph image associated with this character. At scanline 600, noted above, a portion of the “N” glyph is illustrated at FIG. 11. A single bit image, which has not been colored, parts of a bit map that are shown in black are drawn as white and white parts are suitably shown as clear. This information is then appended for each scanline to the prior representation built for the graphic and vector based images. As noted above, if an instruction block has not been allocated yet for y=600, which scanline overlaps the end, one would be allocated.

Once rendering is complete, the system has sufficient recorded information to reproduce the corresponding row of glyph data.

Remaining characters in each text string are handled as described above. It will be appreciated that subsequent letters in the same text string need not have the color set insofar as that has been done so relative to previous character, unless a next character has been chosen to have a different color to that of its predecessor.

Once a complete description for an image, including one or more image portions has been completed, the system proceeds to banding of the image to allow for output. At this stage, the system suitably provides sufficient memory for a full, uncompressed band which is typically 128 scanlines in length in current embodiments. A band is populated by finding each regular scanline that contains a band and the opCodes instructions associated with those bands have been representatively detailed above.

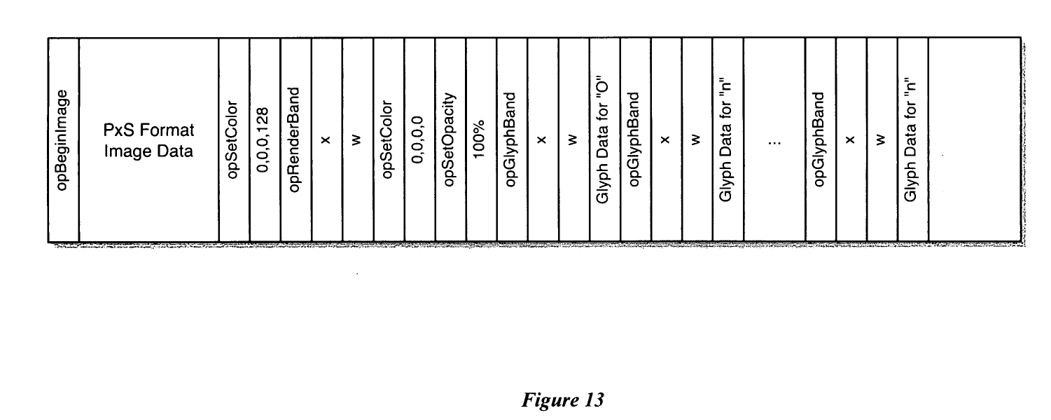

FIG. 13 provides an example of instructions associated with y=7000 at the sample image, described in detail above. Illustrated in the figure is content of a suitable buffer including instructions associated with that scanline. In the rendering process, an associated engine is given a pointer to a block of memory to render the associated scanline. This is completed by processing instructions associated with that scanline. Rendering begins by first resetting a scanline graphics processor to select the defaults. Instructions are then retrieved from a corresponding block and executed so rendering is completed into a destination memory block. An example of scanline y=7000 of FIG. 13, a first opCode is retrieved initially which is the opBeginImage. This opCode suitably addresses a first two bytes which would be a starting x coordinate. Once this value is fetched, the system iterates through the encoded image data in the associated instruction buffer to plot pixels in a corresponding destination memory block.

In the illustrated example, at this point a destination memory block contains a scanline with a one pixel high slice of the moon below Neil Armstrong's feet. Next, opSetColor is then retrieved to set color. In the example, this is the 0, 0, 0, 128 value specifying a gray of the rectangle noted above. The next opCode defined is opRenderBand which retrieves a starting x coordinate and a band width, which will result in a procedure to render a band of the rectangle in gray overtop the previously rendered pictorial image. Next, an opCode is retrieved to render glyph data, which is a slice of the code “O” character, in a selected color, which is white. This rendering is communicated to the destination memory block. Lastly, rendering of text characters is completed for all remaining characters affecting that band. Once all rendering for an associated band is completed, it is ready to be printed onto a final page or otherwise output to a document output device. In the example, once rendering is completed for y=7000, progress is made to the scanline at y=7,001, and so forth, until a page is fully rendered and completely passed to a system for final output.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

Having thus described the invention, it is now claimed:

1. A document rendering system comprising:
a memory allocation unit including,
scanline memory allocation means adapted for allocating a plurality of scanline memory locations, each scanline memory location corresponding to a scanline of a document to be rendered, and
instruction memory allocation means adapted for allocating at least one instruction memory location corresponding to each scanline memory location;
receiving means adapted for receiving an electronic document inclusive of at least one encoded visual output primitive;
conversion means adapted for converting each visual output primitive of a received electronic document into a series of instructions;
association means adapted for associating each instruction with at least one scanline memory location;
storage means adapted for storing each instruction in an instruction memory location allocated by the memory allocation unit and corresponding to a selected scanline memory location; and
output means adapted for communicating an encoded scanline output file, inclusive of content of each instruction memory location corresponding to each scanline memory location, to an associated document rendering device.

2. The document rendering system of claim 1 further comprising:
means adapted for receiving the encoded scanline output file;
decoding means adapted for sequentially decoding instructions of each scanline memory location; and
means adapted for generating a bitmap band output corresponding to decoded instructions of each scanline memory location.

3. The document rendering system of claim 1, wherein each instruction specifies at least one of color, opacity, pattern, pixel range and raster operation code.

4. The document rendering system of claim 1, wherein the receiving means includes means adapted for receiving the electronic document inclusive of a plurality of encoded visual output primitives, such that at least one scanline memory location includes instructions corresponding to each of the plurality of encoded visual output primitives.

5. The document rendering system of claim 4, wherein the decoding means decodes instructions from the at least one scanline memory location inclusive of instructions corresponding to each of the plurality of encoded visual output primitives, such that a decoded instruction generates a bitmap selectively overwrites at least a portion of that associated with a prior decoded instruction.

6. The document rendering system of claim 5, wherein each instruction specifies at least one of color, opacity, pattern, pixel range and raster operation code.

7. The document rendering system of claim 5 wherein at least one instruction includes a raster operation code inclusive of at least of text rendering, general band rendering, graphics rendering, batch rendering and caching.

8. A document rendering method comprising the steps of:
allocating a plurality of scanline memory locations, each scanline memory location corresponding to a scanline of a document to be rendered;
allocating at least one instruction memory location corresponding to each scanline memory location;
receiving an electronic document inclusive of at least one encoded visual output primitive;
converting each visual output primitive of a received electronic document into a series of instructions;
associating each instruction with at least one scanline memory location;
storing each instruction in an instruction memory location corresponding to a selected scanline memory location; and
communicating an encoded scanline output file, inclusive of content of each instruction memory location corresponding to each scanline memory location, to an associated document rendering device.

9. The document rendering method of claim 8 further comprising the steps of:
receiving the encoded scanline output file;
sequentially decoding instructions of each scanline memory location; and
generating a bitmap band output corresponding to decoded instructions of each scanline memory location.

10. The document rendering method of claim 8, wherein each instruction specifies at least one of color, opacity, pattern, pixel range and raster operation code.

11. The document rendering method of claim 8, wherein the step of receiving an electronic document further comprises the step of receiving the electronic document inclusive of a plurality of encoded visual output primitives, such that at least one scanline memory location includes instructions corresponding to each of the plurality of encoded visual output primitives.

12. The document rendering method of claim 11, wherein the step of decoding instructions decodes instructions from the at least one scanline memory location inclusive of instructions corresponding to each of the plurality of encoded visual output primitives, such that a decoded instruction generates a bitmap selectively overwrites at least a portion of that associated with a prior decoded instruction.

13. The document rendering method of claim 12, wherein each instruction specifies at least one of color, opacity, pattern, pixel range and raster operation code.

14. The document rendering system of claim 12, wherein at least one instruction includes a raster operation code inclusive of at least of text rendering, general band rendering, graphics rendering, batch rendering and caching.

15. A computer-implemented method for rendering a document comprising the steps of:
allocating a plurality of scanline memory locations, each scanline memory location corresponding to a scanline of a document to be rendered;
allocating at least one instruction memory location corresponding to each scanline memory location;
receiving an electronic document inclusive of at least one encoded visual output primitive;
converting each visual output primitive of a received electronic document into a series of instructions;
associating each instruction with at least one scanline memory location;
storing each instruction in an instruction memory location corresponding to a selected scanline memory location; and
communicating an encoded scanline output file, inclusive of content of each instruction memory location corresponding to each scanline memory location, to an associated document rendering device.

16. The computer-implemented method for rendering a document of claim 15 further comprising the steps of:
receiving the encoded scanline output file;
sequentially decoding instructions of each scanline memory location; and
generating a bitmap band output corresponding to decoded instructions of each scanline memory location.

17. The computer-implemented method for rendering a document of claim 15, wherein each instruction specifies at least one of color, opacity, pattern, pixel range and raster operation code.

18. The computer-implemented method for rendering a document of claim 15, wherein the step of receiving an electronic document further comprises the step of receiving the electronic document inclusive of a plurality of encoded visual output primitives, such that at least one scanline memory location includes instructions corresponding to each of the plurality of encoded visual output primitives.

19. The computer-implemented method for rendering a document of claim 18, wherein the step of decoding instructions decodes instructions from the at least one scanline memory location inclusive of instructions corresponding to each of the plurality of encoded visual output primitives, such that a decoded instruction generates a bitmap selectively overwrites at least a portion of that associated with a prior decoded instruction.

20. The computer-implemented method for rendering a document of claim 19, wherein each instruction specifies at least one of color, opacity, pattern, pixel range and raster operation code.

21. The computer-implemented method for rendering a document of claim 19, wherein at least one instruction includes a raster operation code inclusive of at least of text rendering, general band rendering, graphics rendering, batch rendering and caching.
